(19) United States
(12) Patent Application Publication
(10) Pub. No.: US 2015/0187137 A1
(43) Pub. Date: Jul. 2, 2015

(54) PHYSICAL OBJECT DISCOVERY

(71) Applicant: DAQRI, LLC, Los Angeles, CA (US)

(72) Inventor: Brian Mullins, Sierra Madre, CA (US)

(21) Appl. No.: 14/145,182

(22) Filed: Dec. 31, 2013

(51) Int. Cl. G06T 19/00; G06F 3/0484; H04L 12/18

(52) U.S. Cl. CPC G06T 19/006; H04L 12/189; G06F 3/0484; G06T 2200/24; G06T 2215/16

(57) ABSTRACT

A system and method for discovering a machine using an augmented reality application in a viewing device is described. A default virtual user interface is associated with the machine. The machine broadcasts a status of the machine, the default virtual user interface associated with the machine, and tracking data related to the machine to the viewing device authenticated with the machine and in proximity to the machine. The visualization of the status of the machine object and the default virtual user interface are rendered in a display of the viewing device.

### TECHNICAL FIELD

The subject matter disclosed herein generally relates to the processing of data. Specifically, the present disclosure addresses systems and methods for an open world discovery of physical objects.

### BACKGROUND

A device can be used to generate and display data in addition an image captured with the device. For example, augmented reality (AR) is a live, direct or indirect, view of a physical, real-world environment whose elements are augmented by computer-generated sensory input such as sound, video, graphics or GPS data. With the help of advanced AR technology (e.g. adding computer vision and object recognition) the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network suitable for assigning a virtual user interface to a physical object, according to some example embodiments.

FIG. 2 is a block diagram illustrating an example embodiment of modules (e.g., components) of a viewing device.

FIG. 3 is a block diagram illustrating an example embodiment of a physical object discovery module.

FIG. 4 is a block diagram illustrating an example embodiment of a virtual user interface rendering module.

FIG. 5 is a block diagram illustrating an example embodiment of modules of a factory machine.

FIG. 6 is a block diagram illustrating an example embodiment of modules of a server.

FIG. 7 is a ladder diagram illustrating an example embodiment of a discovery process using augmented reality application at a viewing device.

FIG. 8 is a flowchart illustrating an example operation of a discovery process using an augmented reality application.

FIG. 9 is a flowchart illustrating an example operation of assigning of user interface to a physical object.

FIG. 10 is a flowchart illustrating an example operation of retrieving a virtual user interface.

FIG. 11 is a diagram illustrating an example operation of physical object discovery using an augmented reality application at a server.

FIG. 12 is a block diagram illustrating components of a machine, according to some example embodiments, able to read instructions from a machine-readable medium and perform any one or more of the methodologies discussed herein.

FIG. 13 is a block diagram illustrating a mobile device, according to an example embodiment.

### DETAILED DESCRIPTION

Example methods and systems are directed to data manipulation based on real world object manipulation. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Augmented reality applications allow a user to experience information, such as in the form of a three-dimensional virtual object overlaid on an image of a physical object captured by a camera of a viewing device. The physical object may include a visual reference that the augmented reality application can identify. A visualization of the additional information, such as the three-dimensional virtual object overlaid or engaged with an image of the physical object is generated in a display of the device. The three-dimensional virtual object may selected based on the recognized visual reference or captured image of the physical object. A rendering of the visualization of the three-dimensional virtual object may be based on a position of the display relative to the visual reference. Other augmented reality applications allow a user to experience visualization of the additional information overlaid on top of a view or an image of any object in the real physical world. The virtual object may include a three-dimensional virtual object, a two-dimensional virtual object. For example, the three-dimensional virtual object may include a three-dimensional view of a chair or an animated dinosaur. The two-dimensional virtual object may include a two-dimensional view of a dialog box, menu, or written information such as statistics information for a baseball player. An image of the virtual object may be rendered at the viewing device. The virtual object may include a virtual user interface or information (e.g., what it is, where it is, what are its function and operating status) identifying a physical object. The physical object may also be referred to as a machine since it can be connected to a computer network. The machine may be an appliance, a factory machine, or any other mechanical device capable of communicating over a computer network.

A system and method for discovering a machine using an augmented reality application in a viewing device is described. A default virtual user interface may be associated with the machine. The machine broadcasts a status of the machine, the default virtual user interface associated with the machine, and tracking data related to the machine to the viewing device authenticated with the machine and in proximity to the machine. The visualization of the status of the machine and the default virtual user interface are rendered in a display of the viewing device.

In one example embodiment, the viewing device comprises an augmented reality application that generates directions to the machine or descriptions of the machine using the tracking data in the display of the viewing device.

In one example embodiment, the viewing device receives the broadcast from the machine after an authentication of the viewing device with a server coupled to the machine.

The status can include a presence, an operating status, and operating features of the machine, characteristics of the machine. The default virtual user interface includes a virtual user interface defined by the machine and can be modified based on the status of the machine. The visualization of the default virtual user interface can be generated in relation to a location of the machine relative to the viewing device. The tracking data includes an identification of a physical location, a shape, or a physical identifier of the machine. The machine determines a location of the viewing device related to the machine. The tracking data may be relative to the location of the viewing device.

The virtual user interface may include a menu of information identifying the machine, interactive virtual functions associated with functions of the machine. The viewing device may include a physical object identifier module configured to generate identifiers of the machine comprising feature points of the machine. The tracking data may include a location of the machine, a location of the viewing device relative to the machine, an orientation of the viewing device, and a distance between the location of the viewing device and the location of the machine.

In another example embodiment, a non-transitory machine-readable storage device may store a set of instructions that, when executed by at least one processor, causes the at least one processor to perform the method operations discussed within the present disclosure.

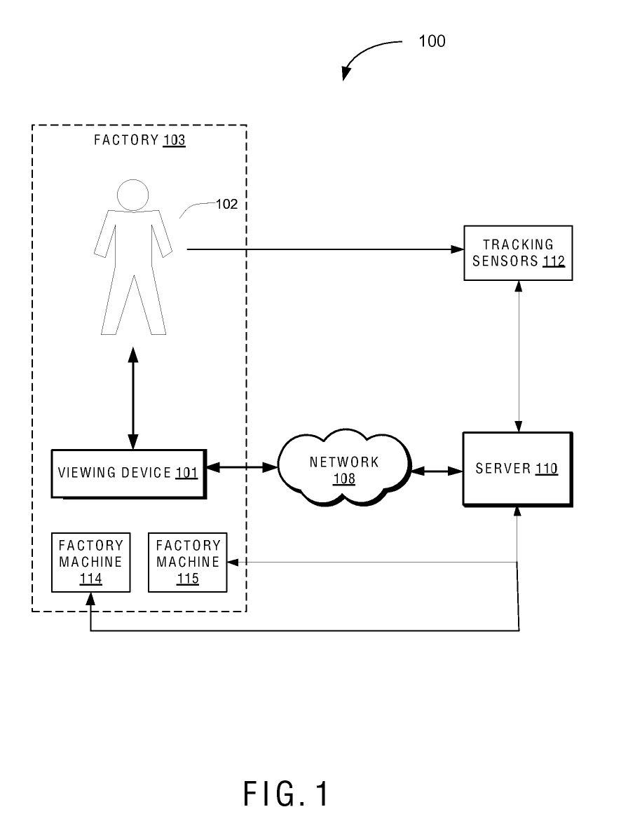

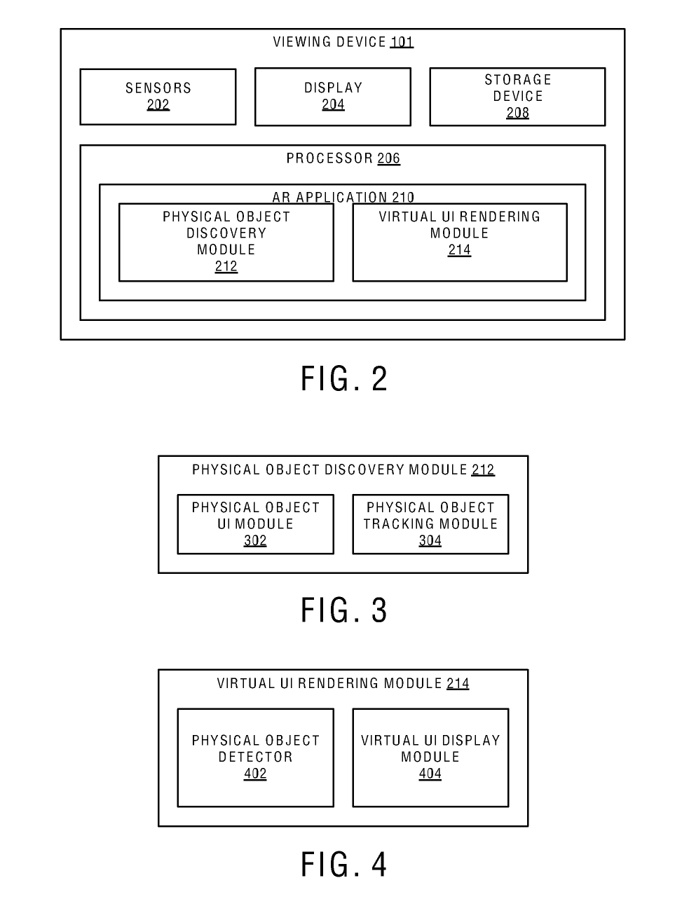

FIG. 1 is a network diagram illustrating a network environment 100 suitable for operating an augmented reality application of a device, according to some example embodiments. The network environment 100 includes a viewing device 101 and a server 110, communicatively coupled to each other via a network 108. The viewing device 101 and the server 110 may each be implemented in a computer system, in whole or in part, as described below with respect to FIGS. 2 and 6.

The server 110 may be part of a network-based system. For example, the network-based system may be or include a cloud-based server system that provides additional information such, as three-dimensional models, to the viewing device 101.

A user 102 may utilize the viewing device 101 to capture a view of a machine (e.g., factory machine) connected to a network in a local real world environment such as at a factory 103 or a kitchen. The user 102 may be a human user (e.g., a human being), a machine user (e.g., a computer configured by a software program to interact with the device 101), or any suitable combination thereof (e.g., a human assisted by a machine or a machine supervised by a human). The user 102 is not part of the network environment 100, but is associated with the viewing device 101 and may be a user 102 of the viewing device 101.

For example, the viewing device 101 may be a wearing computing device, desktop computer, a vehicle computer, a tablet computer, a navigational device, a portable media device, or a smart phone of a user. The user may be a human user (e.g., a human being), a machine user (e.g., a computer configured by a software program to interact with the viewing device 101), or any suitable combination thereof (e.g., a human assisted by a machine or a machine supervised by a human). The computing device may be hand held or may be removable mounted to a head of the user. In one example, the display may be a screen that displays what is captured with a camera of the viewing device. In another example, the display of the device may be transparent or semi-transparent such as in lenses of wearable computing glasses.

The user 102 may be a user of an augmented reality application in the viewing device 101 and at the server 110. The augmented reality application may provide the user 102 with an experience triggered by a physical object having a network presence (e.g., factory machine 114, 115), a two-dimensional physical object (e.g., a picture), a three-dimensional physical object without any network presence, a location (e.g., at the bottom floor of a factory), or any references (e.g., perceived corners of walls or furniture) in the real world physical environment. For example, the user 102 may point a camera of the viewing device 101 to capture an image of the factory machine 114. The image is tracked and recognized locally in the viewing device 101 using a local context recognition dataset or any other previously stored dataset of the augmented reality application of the viewing device 101. The local context recognition dataset module may include a library of virtual objects associated with real-world physical objects or references. In one example, the viewing device 101 identifies feature points in an image of the factory machine 114 to determine different planes of the factory machine 114 (e.g., edges, corners, surface of the machine). The viewing device 101 also identifies tracking data related to the factory machine 114 (e.g., first floor in unit A of the factory, facing west, viewing device 101 standing five feet away from the factory machine 114, etc.). The viewing device 101 may allow the user 102 to display information about the factory machine 114 (e.g., machine name A for drilling) at the viewing device 101 by rendering a default virtual user interface associated with the factory machine 114 at the viewing device 101 using the tracking data with or without the feature points.

In another embodiment, the server 110 may operate to receive the feature points in an image of the factory machine 114 from the viewing device 101. Feature points may include points defining a plane in the image of the factory machine. The plane may be determined based on fixes points along the plane relative to a movement of the viewing device with respect to the factory machine 114. The server 110 then identifies tracking data related to the factory machine 114 as detected by internal sensors in the viewing device 101 and by tracking sensors 112 external to the viewing device 101. The server 110 then retrieve a virtual user interface to display information about the factory machine 114 (e.g., machine name A for drilling) by associating the virtual interface with feature points and the tracking data related to the factory machine 114.

The augmented reality application in the viewing device 101 and at the server 110 can subsequently generate additional information (e.g., virtual user interface) corresponding to the image (e.g., a two-dimensional or three-dimensional model) being captured by the viewing device 101 and presents this additional information in a display of the viewing device 101 in response to identifying the recognized image. If the captured image is not recognized locally at the viewing device 101, the viewing device 101 downloads additional information (e.g., the three-dimensional model) corresponding to the captured image, from a database of the server 110 over the network 108.

In another example embodiment, the user 102 may enter a factory 103 having multiple factory machines, such as factory machine 114, 115. The factory machine 114, 115 may include a computer connected to the server 110. Once the user 102 is authenticated with the server 110 associated with the factory 103, factory machine 114 may broadcast to the viewing device 101 of the user 102 the presence of the factory machine 114, the default user interface provided by a manufacturer of the factory machine 114, the location of the factory machine 114 within the factory 103, a unique identifier of the factory machine 114, operating status of the factory machine 114, and operating features (what the machine can do) of the factory machine 114. As such, the user 102 who may not be familiar with the factory 103 and factory machine 114 can locate, identify, and operate the factory machine 114. The default virtual user interface may be set by previous authorized users of the factory machine 114 or from the manufacturer of the factory machine 114. The augmented reality application in the viewing device 101 of the user 102 can help the user 102 locate the factory machine 114 by providing navigational information and identifying information in a display of the viewing device 101. The navigational information may be generated based on tracking data of the viewing device 101 or based on external tracking data from tracking sensors 112 of the server 110.

The tracking sensors 112 may be used to track the location and orientation of the viewing device 101 externally without having to rely on the sensors internal to the viewing device 101. The tracking sensors 112 may include optical sensors (e.g., depth-enabled 3D camera), wireless sensors (Bluetooth, wifi), GPS sensor, and audio sensor to determine the location of the user 102 having the viewing device 101, distance of the user to the tracking sensors 112 in the physical environment (e.g., sensors placed in corners of a venue or a room), the orientation of the viewing device 101 to track what the user 102 is looking at (e.g., direction at which the viewing device 102 is pointed, viewing device 102 pointed towards a player on a tennis court, viewing device 102 pointed at a person in a room).

In another embodiment, data from the tracking sensors 112 and internal sensors in the viewing device 101 may be used for analytics data processing at the server 110 for analysis on usage and how the user 102 is interacting with the physical environment. For example, the analytics data may track at what the locations (e.g., points or features) on the physical or virtual object the user 102 has looked, how long the user 102 has looked at each location on the physical or virtual object, how the user 102 held the viewing device 101 when looking at the physical or virtual object, which features of the virtual object the user 102 interacted with (e.g., such as whether a user 102 tapped on a link in the virtual object), and any suitable combination thereof. The viewing device 101 receives a visualization content dataset related to the analytics data. The viewing device 101 then generates a virtual object with additional or visualization features, or a new experience, based on the visualization content dataset.

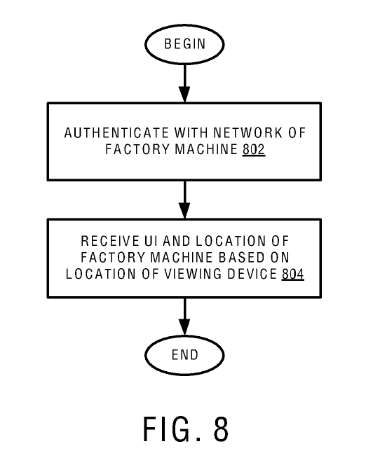

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 8, 9, 10. As used herein, a “database” is a data storage resource and may store data structured as a text file, a table, a spreadsheet, a relational database (e.g., an object-relational database), a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

FIG. 2 is a block diagram illustrating modules (e.g., components) of the viewing device 101, according to some example embodiments. The viewing device 101 may include sensors 202, a display 204, a processor 206, and a storage device 208. For example, the viewing device 101 may be a wearing computing device, desktop computer, a vehicle computer, a tablet computer, a navigational device, a portable media device, or a smart phone of a user. The user may be a human user (e.g., a human being), a machine user (e.g., a computer configured by a software program to interact with the viewing device 101), or any suitable combination thereof (e.g., a human assisted by a machine or a machine supervised by a human).

The sensors 202 may include, for example, a proximity or location sensor (e.g, Near Field Communication, GPS, Bluetooth, Wifi), an optical sensor (e.g., camera), an orientation sensor (e.g., gyroscope), an audio sensor (e.g., a microphone), or any suitable combination thereof. For example, the sensors 202 may include a rear facing camera and a front facing camera in the viewing device 101. It is noted that the sensors described herein are for illustration purposes and the sensors 202 are thus not limited to the ones described. The sensors 202 may be used to generate internal tracking data of the viewing device 101 to determine what the viewing device 101 is capturing or looking at in the real physical world.

The display 204 may include, for example, a touchscreen display configured to receive a user input via a contact on the touchscreen display. In one example, the display 204 may include a screen or monitor configured to display images generated by the processor 206. In another example, the display 204 may be transparent or semi-opaque so that the user can see through the display 104 (e.g., Head-Up Display).

The processor 206 may include an augmented reality application 210 for rendering a virtual user interface and navigational data to a machine when the viewing device 101 receives a broadcast from the machine. In one example embodiment, the augmented reality application 212 may include a physical object discovery module 212 and a virtual user interface rendering module 214.

The physical object discovery module 214 allows the user of the viewing device 101 to identify and locate the physical object, and operate the physical object by using a default virtual user interface related to the physical object. For example, the virtual user interface may include information or status about the physical object (e.g., what the machine looks like, how it operates, warranty information, manufacturer, etc). The physical object discovery module 212 may include a physical object user interface module 302 and a physical object tracking module 304 as illustrated in FIG. 3. The physical object user interface module 302 may be configured to receive the default virtual user interface related to the physical object. For example, the default virtual user interface may include factory name, machine name, authorized operators of the machine, etc. The default virtual user interface may be associated with physical objects having similar characteristics, such as location, operators, type of machine, etc. As such, factory machines from a same manufacturer and performing the same functions may have the same default virtual user interface.

The physical object tracking module 304 allows the user of the viewing device 101 to identify the presence of the factory machine 114 and to track its location inside the factory 103. The location of the viewing device 101 may be determined using sensors internal to the viewing device 101 or sensors external to the viewing device 101 to determine a location of the viewing device 101 inside the factory related to the factory machine 114.

In one example embodiment, the augmented reality application 210 includes a physical object identifier module that may detect, generate, and identify identifiers such as feature points of the physical object being viewed or pointed at the viewing device using an optical device of the viewing device 101 to capture the image of the physical object. As such, the physical object identifier module may be configured to identify a physical object. However, because machines may resemble one another on a factory floor, the physical object identifier module may use tracking data to further assist in identifying the unique physical object.

The virtual user interface rendering module 214 generates a visualization of the virtual user interface broadcast from the factory machine 114. In another example, the visualization of the virtual user interface may be based on feature points of the physical object and the tracking data from sensors 202. In one example embodiment, the virtual user interface rendering module 218 includes a physical object detector 402 and a virtual user interface display module 404 as illustrated in FIG. 4. The physical object detector 502 detects and identifies the physical object being viewed by the viewing device 101. The virtual user interface generating module 504 generates a visualization of the virtual user interface in the display 204.

In one example, the viewing device 101 accesses from a local memory the virtual user interface dataset corresponding to the image of the physical object. In another example, the viewing device 101 receives a virtual user interface dataset corresponding to an image of the physical object from the server 110. The viewing device 101 then renders the virtual user interface to be displayed in relation to an image of the physical object being displayed in the viewing device or in relation to a position and orientation of the viewing device 101 relative to the physical object. The augmented reality application 210 may adjust a position of the rendered virtual user interface in the display 204 to correspond with the last tracked position of the chair (as last detected either from the sensors 202 viewing device 101 or from the tracking sensors 112 of the server 110).

The virtual user interface display module 404 may include a local rendering engine that generates a visualization of a three-dimensional virtual object overlaid (e.g., superimposed upon, or otherwise displayed in tandem with) on an image of a physical object captured by a camera of the viewing device 101 in the display 204 of the viewing device 101. A visualization of the three-dimensional virtual object may be manipulated by adjusting a position of the physical object (e.g., its physical location, orientation, or both) relative to the camera of the viewing device 101. Similarly, the visualization of the three-dimensional virtual object may be manipulated by adjusting a position camera of the viewing device 101 relative to the physical object.

In one example embodiment, the virtual user interface generating module 504 may retrieve three-dimensional models of virtual objects associated with a real world physical object captured using the tracking module 216. For example, the captured image may include a visual reference (also referred to as a marker) that consists of an identifiable image, symbol, letter, number, machine-readable code. For example, the visual reference may include a bar code, a quick response (QR) code, or an image that has been previously associated with a three-dimensional virtual object (e.g., an image that has been previously determined to correspond to the three-dimensional virtual object).

In one example embodiment, the virtual user interface rendering module 218 may include a manipulation module that identifies the physical object (e.g., a physical telephone), access virtual functions (e.g., increase or lower the volume of a nearby television) associated with physical manipulations (e.g., lifting a physical telephone handset) of the physical object, and generate a virtual function corresponding to a physical manipulation of the physical object.

In another example embodiment, the viewing device 101 includes a contextual local image recognition module (not shown) configured to determine whether the captured image matches an image locally stored in a local database of images and corresponding additional information (e.g., three-dimensional model and interactive features) on the viewing device 101. In one embodiment, the contextual local image recognition module retrieves a primary content dataset from the server 110, generates and updates a contextual content dataset based an image captured with the viewing device 101.

The storage device 208 may be configured to store a database of identifiers of physical object, tracking data, and corresponding virtual user interfaces. In another embodiment, the database may also include visual references (e.g., images) and corresponding experiences (e.g., three-dimensional virtual objects, interactive features of the three-dimensional virtual objects). For example, the visual reference may include a machine-readable code or a previously identified image (e.g., a picture of shoe). The previously identified image of the shoe may correspond to a three-dimensional virtual model of the shoe that can be viewed from different angles by manipulating the position of the viewing device 101 relative to the picture of the shoe. Features of the three-dimensional virtual shoe may include selectable icons on the three-dimensional virtual model of the shoe. An icon may be selected or activated by tapping or moving on the viewing device 101.

In one embodiment, the storage device 208 includes a primary content dataset, a contextual content dataset, a visualization content dataset. The primary content dataset includes, for example, a first set of images and corresponding experiences (e.g., interaction with three-dimensional virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most popular magazines and their corresponding experiences (e.g., virtual objects that represent the ten most popular magazines). In another example, the server 110 may generate the first set of images based on the most popular or often scanned images received at the server 110. Thus, the primary content dataset does not depend on objects or images scanned by the rendering module 214 of the viewing device 101.

The contextual content dataset includes, for example, a second set of images and corresponding experiences (e.g., three-dimensional virtual object models) retrieved from the server 110. For example, images captured with the viewing device 101 that are not recognized (e.g., by the server 110) in the primary content dataset are submitted to the server 110 for recognition. If the captured image is recognized by the server 110, a corresponding experience may be downloaded at the viewing device 101 and stored in the contextual content dataset. Thus, the contextual content dataset relies on the context in which the viewing device 101 has been used. As such, the contextual content dataset depends on objects or images scanned by the rendering module 214 of the viewing device 101.

In one embodiment, the viewing device 101 may communicate over the network 108 with the server 110 to retrieve a portion of a database of visual references, corresponding three-dimensional virtual objects, and corresponding interactive features of the three-dimensional virtual objects. The network 108 may be any network that enables communication between or among machines, databases, and devices (e.g., the viewing device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

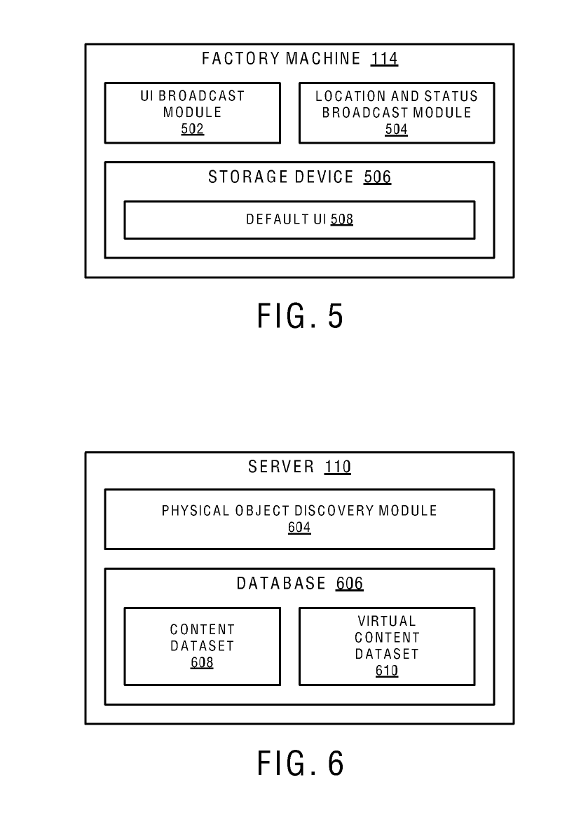

FIG. 5 is a block diagram illustrating modules (e.g., components) of the factory machine 114, according to some example embodiments. The factory machine 114 includes a user interface module 502, a location and status broadcast module 504, and a storage device 506.

The user interface module 502 generates a broadcast of the virtual user interface of the factory machine 114 over a local network in the factory 103. In one example embodiment, the user interface module 502 communicates with the server 110 to broadcast the factory machine 114 information to authenticated viewing devices that are located in proximity or within the factory 103. The location and status broadcast module 504 generates a broadcast of the geographic location and operating status of the factory machine 114. The storage device 506 stores the default user interface associated with the factory machine 114.

FIG. 6 is a block diagram illustrating modules (e.g., components) of the server 110. The server 110 includes a physical object discovery module 604 and a database 606.

The physical object discovery module 604 allows a user to discover the presence and the location of a device based on tracking data related to the physical object. The physical object discovery module 604 may interface and communicate with tracking sensors 112 to obtain data related to a geographic position, a location, an orientation of the viewing device 101. In one example embodiment, the physical object discovery module 604 receives the feature points and tracking data from the viewing device 101. In another example embodiment, the physical object discovery module 604 receive a frame or an image of the physical object from the viewing device 101 and determines the feature points and tracking data related to the physical object based on the received image. The physical object discovery module 604 may include a computer vision recognition algorithm.

In another example embodiment, the default virtual user interface may be previously assigned to the factory machine 114 by a manufacturer of the factory machine 114 using a training module that may be configured to associate the identified physical object with a virtual user interface formed at the content generator 602. In another example, the default virtual user interface may be preset or predefined by a previous user of the machine. For example, an operator of the machine may find it that a particular user interface is to be rendered when viewing the machine based on his experience. The training module 612 may generate a model of a virtual object to be rendered in the display of the viewing device 101 based on a position of the viewing device 101 relative to the physical object. A physical movement of the physical object is identified from an image captured by the viewing device 101. The training module 612 may also determine a virtual object corresponding to the tracking data (either received from the viewing device 101 or generated externally to the viewing device 101) and render the virtual object. Furthermore, the tracking data may identify real world object being looked at the viewing device 101. The virtual object may include a manipulative virtual object or displayed augmented information associated.

The database 606 may store a content dataset 608, a virtual content dataset 610. The content dataset 608 may store a primary content dataset and a contextual content dataset. The primary content dataset comprises a first set of images and corresponding virtual object models. The physical objet detector 604 determines that a captured image received from the viewing device 101 is not recognized in the content dataset 610, and generates the contextual content dataset for the viewing device 101. The contextual content dataset may include a second set of images and corresponding virtual object models. The virtual content dataset 610 includes models of virtual objects to be generated upon receiving a notification associated with an image of a corresponding physical object.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

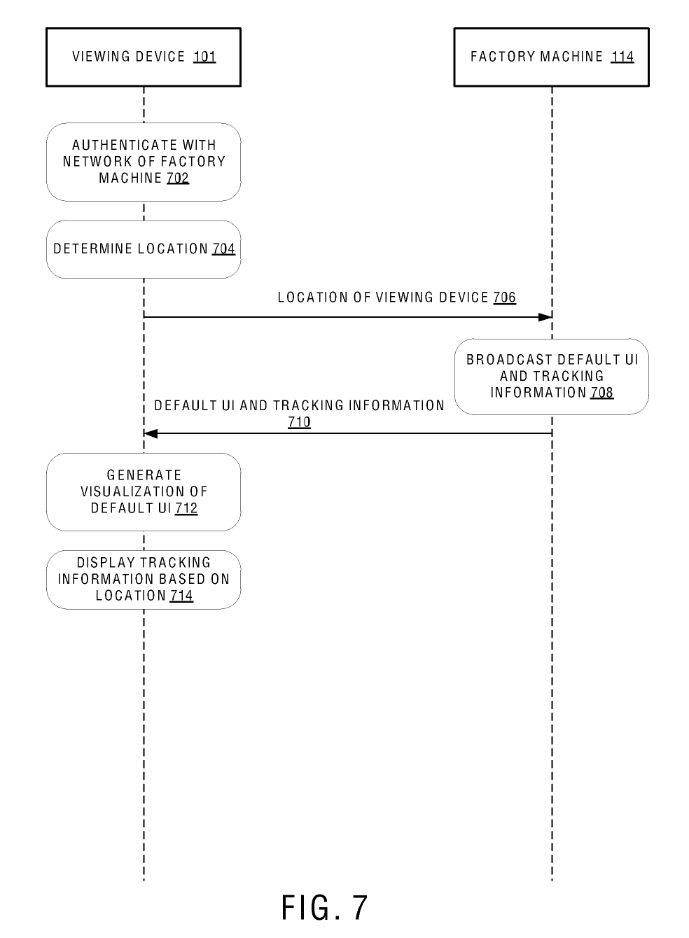

FIG. 7 is a ladder diagram illustrating an example embodiment of training an augmented reality application at a viewing device. At operation 702, the viewing device 101 is authenticated with a computer network related to the factory machine 114. At operation 704, the viewing device 101 determines its location relative to the factory machine 114 using for example, GPS information, Bluetooth, compass, wifi data. Tracking data related to the factory machine 114 may be captured by the viewing device 101. At operation 706, the viewing device 101 communicates its presence and its relative location to the factory machine 114 or the server 110 associated with the factory machine 114.

At operation 708, after authentication of the viewing device 101, the factory machine 114 broadcasts its default user interface and tracking information to the viewing device. As such, the factory machine 114 notifies the viewing device 101 of its presence and tells the viewing device 101 how to locate the factory machine 114. At operation 710, the viewing device 101 receives the default user interface and tracking information from the factory machine 114. At operation 712, the viewing device 101 generates a visualization of the default virtual user interface in relation to the factory machine 114. At operation 714, the viewing device displays tracking information based on the location of the viewing device. For example, the tracking information may include a distance and direction, a location (corner of a room), or a description of what the factory machine 114 looks like.

FIG. 8 is a flowchart illustrating an example operation of broadcasting a default user interface to an augmented reality application of a viewing device. At operation 802, the viewing device is authenticated with a network of factory machine. At operation 804, the viewing device receives the default user interface and location of the factory machine based on the location of the viewing device relative to the factory machine. The viewing device can then display the default user interface in related to the corresponding factory machine.

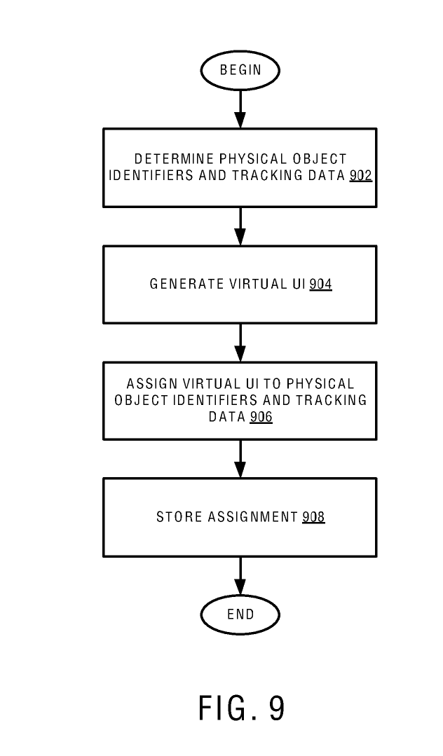

FIG. 9 is a flowchart illustrating an example operation of training an augmented reality application. At operation 902, physical object identifiers and tracking data are determined. At operation 904, A virtual user interface is generated based on the physical object identifiers and tracking data. At operation 906, the virtual user interface are assigned to the physical object identifiers and tracking data. At operation 908, the assignment and relationship is stored in a storage device. The training of the augmented reality application may be performed at the viewing device 101 or at the server 110.

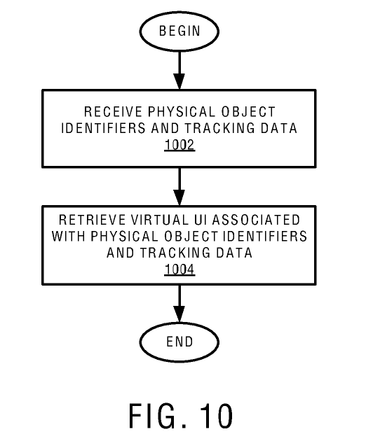

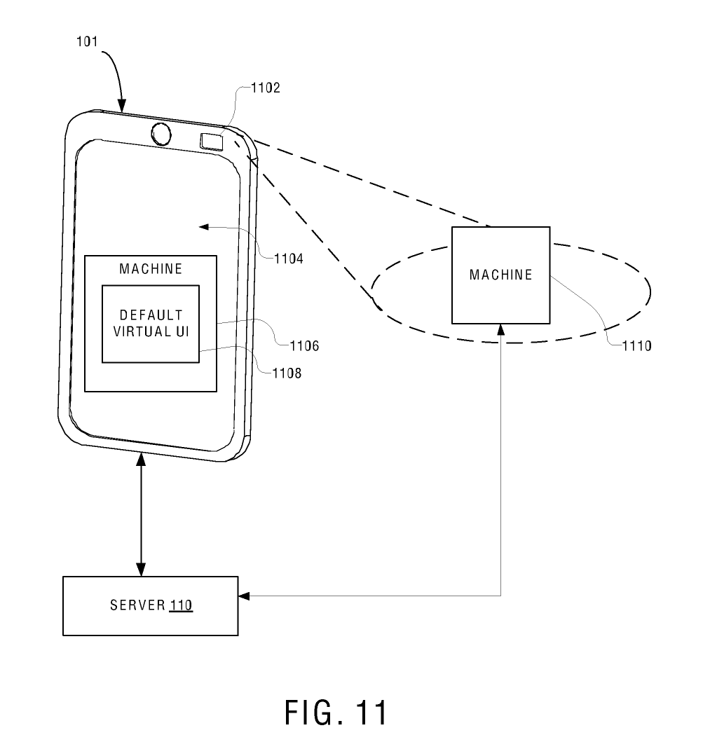

FIG. 10 is a flowchart illustrating an example operation of retrieving a virtual user interface. At operation 1002, physical object identifiers and tracking data are received or identified. But operation 1004, the corresponding virtual user interface is retrieved based on the received physical object identifiers and tracking data. The retrieval of the virtual user interface may be performed at the viewing device 101 or at the server 110.

FIG. 11 is a diagram illustrating an example operation of discovering a default user interface using an augmented reality application at a viewing device. The viewing device 101 may include a handheld mobile device having a rear view camera 1102 and a touch sensitive display 1104. The viewing device 101 may be pointed at a machine 1110. The rearview camera 1102 captures an image of the machine 1110 and displays a picture 1106 of the machine 1110 in the display 1104. Identifiers and tracking data related to the machine 1110 may be determined by the viewing device 101 based on the picture 1106 of the machine 1110. The default virtual user interface 1108 may be displayed in relation to the image 1106 of the machine 1110 (e.g., on the left side of machine). In another embodiment, the association of the selected virtual user interface 1108 with the machine 1110 may be stored at the server 110.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

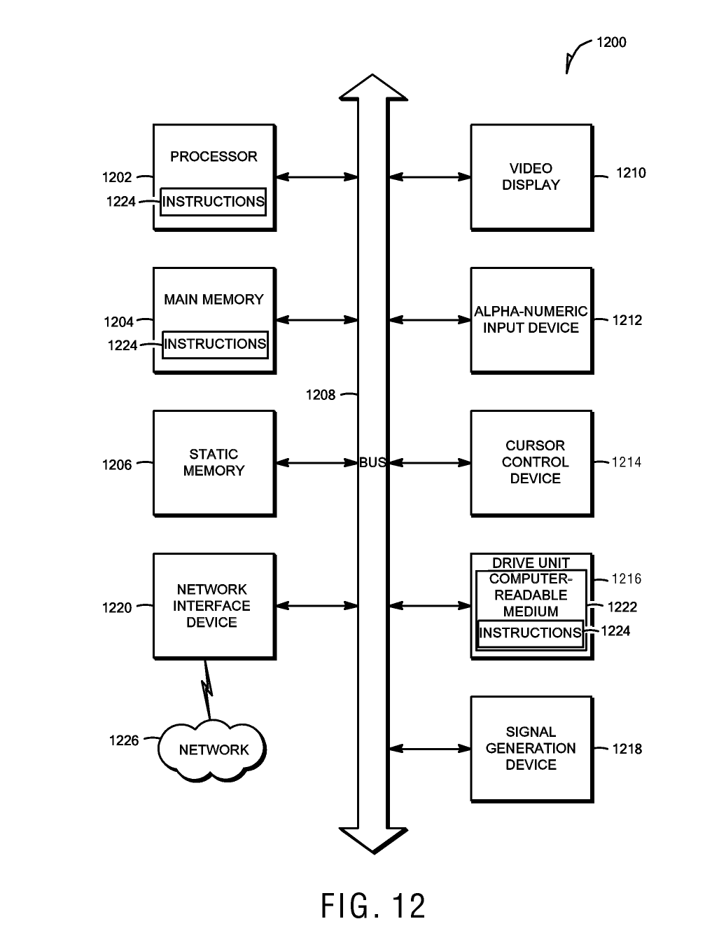

FIG. 12 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

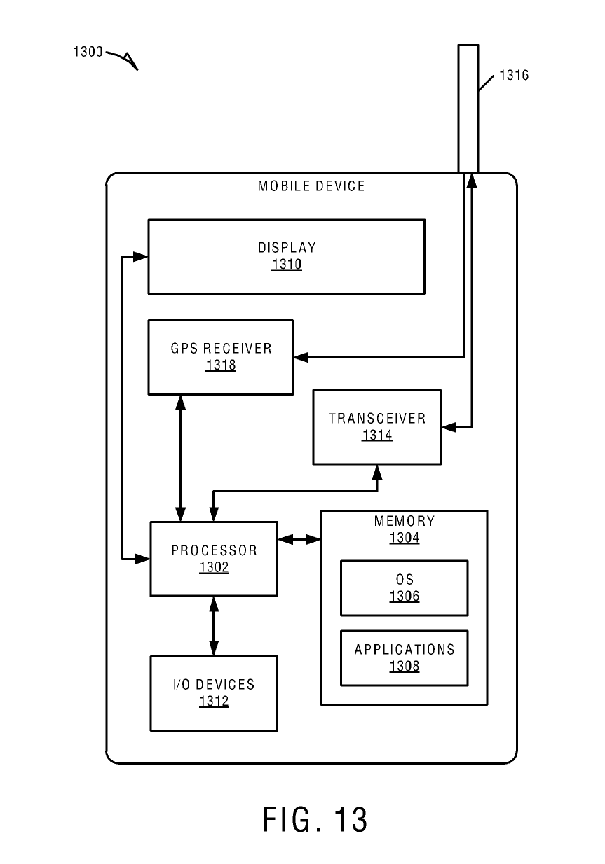

FIG. 13 is a block diagram illustrating a mobile device 1300, according to an example embodiment. The mobile device 1000 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or other type of memory, is typically accessible to the processor 1302. The memory 1304 may be adapted to store an operating system (OS) 1306, as well as application programs 1308, such as a mobile location enabled application that may provide location based services to a user. The processor 1302 may be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 may also make use of the antenna 1316 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A machine comprising:
a processor having a virtual user interface broadcast module, a location and status broadcast module,
the virtual user interface broadcast module configured to generate a default virtual user interface associated with the machine; and
the location and status broadcast module configured to broadcast a status of the machine, the default virtual user interface associated with the machine, and tracking data related to the machine to a viewing device authenticated with the machine and in proximity to the machine, the viewing device rendering a visualization of the status of the machine object and the default virtual user interface in a display of the viewing device.

2. The machine of claim 1, wherein the viewing device comprises:
a processor having an augmented reality application, the augmented reality application having:
a virtual user interface rendering module configured to generate directions to the machine using the tracking data in the display of the viewing device.

3. The machine of claim 2, wherein the augmented reality application is configured to receive the broadcast from the machine, the broadcast received after an authentication of the viewing device with a server coupled to the machine.

4. The machine of claim 1, wherein the status includes a presence, an operating status, and operating features of the machine.

5. The machine of claim 1, wherein the default virtual user interface includes a virtual user interface defined by the machine.

6. The machine of claim 1, wherein the default virtual user interface is modified based on the status of the machine.

7. The machine of claim 1, wherein the visualization of the default virtual user interface is generated in relation to a location of the machine relative to the viewing device.

8. The machine of claim 1, wherein the tracking data includes an identification of a physical location, a shape, or a physical identifier of the machine.

9. The machine of claim 1, wherein the machine determines a location of the viewing device related to the machine, the tracking data relative to the location of the viewing device.

10. The machine of claim 1, wherein the virtual user interface comprises a menu of information identifying the machine, interactive virtual functions associated with functions of the machine,
wherein the viewing device comprises:
a physical object identifier module configured to generate identifiers of the machine comprising feature points of the machine,
wherein the tracking data comprise a location of the machine, a location of the viewing device relative to the machine, an orientation of the viewing device, and a distance between the location of the viewing device and the location of the machine.

11. A method comprising:
generating a default virtual user interface associated with a machine;
broadcasting a status of the machine, the default virtual user interface associated with the machine, and tracking data related to the machine to a viewing device authenticated with the machine and in proximity to the machine; and
rendering a visualization of the status of the machine object and the default virtual user interface in a display of the viewing device.

12. The method of claim 11, further comprising:
generating directions to the machine using the tracking data in the display of the viewing device.

13. The method of claim 12, further comprising:
broadcasting to the viewing device after an authentication of the viewing device with a server coupled to the machine.

14. The method of claim 11, wherein the status includes a presence, an operating status, and operating features of the machine.

15. The method of claim 11, wherein the default virtual user interface includes a virtual user interface defined by the machine and modified based on the status of the machine.

16. The method of claim 11, wherein the visualization of the default virtual user interface is generated in relation to a location of the machine relative to the viewing device.

17. The method of claim 11, wherein the tracking data includes an identification of a physical location, a shape, or a physical identifier of the machine.

18. The method of claim 11, further comprising:
determining a location of the viewing device related to the machine, the tracking data relative to the location of the viewing device.

19. The method of claim 11, wherein the virtual user interface comprises a menu of information identifying the machine, and interactive virtual functions associated with functions of the machine,
wherein the viewing device comprises:
a physical object identifier module configured to generate identifiers of the machine comprising feature points of the machine,
wherein the tracking data comprise a location of the machine, a location of the viewing device relative to the machine, an orientation of the viewing device, and a distance between the location of the viewing device and the location of the machine.

20. A non-transitory machine-readable medium comprising instructions that, when executed by one or more processors of a machine, cause the machine to perform operations comprising:
generating a default virtual user interface associated with a machine;
broadcasting a status of the machine, the default virtual user interface associated with the machine, and tracking data related to the machine to a viewing device authenticated with the machine and in proximity to the machine; and
rendering a visualization of the status of the machine object and the default virtual user interface in a display of the viewing device.
